(19) United States
(12) Patent Application Publication
(10) Pub. No.: US 2017/0369740 A1
(43) Pub. Date: Dec. 28, 2017

(54) CROSS-LINKABLE COATING COMPOUNDS BASED ON ORGANYL-OXYSILANE-TERMINATED POLYMERS

(71) Applicant: Wacker Chemie AG, Munich (DE)

(72) Inventors: Volker STANJEK, Ampfing (DE); Dominik AUER, Muehldorf (DE); Andreas BAUER, Kirchdorf (DE); Kurt REITMAJER, Kirchdorf (DE); Lars ZANDER, Altoetting (DE)

(73) Assignee: Wacker Chemie AG, Munich (DE)

(21) Appl. No.: 15/545,806

(22) PCT Filed: Jan. 19, 2016
(86) PCT No.: PCT/EP2016/050940

§ 371 Date: Jul. 24, 2017

(30) Foreign Application Priority Data
Jan. 22, 2015 (DE) 10 2015 201 099.6

(51) Int. Cl. C09D 183/08; B05D 3/00; C08K 3/36; C08K 3/00; C08K 3/22

(52) U.S. Cl. CPC C09D 183/08; B05D 3/007; C08K 2003/2227; C08K 3/22; C08K 3/0033; C08K 2201/005; C08K 3/36

(57) ABSTRACT

Floor coatings with improved properties are prepared from alkoxysilyl-functional polymers, silicone resins with a high alkoxy group content, and a filler component, at least a portion of which contains large particle sizes.

### CROSS REFERENCE TO RELATED APPLICATIONS

This application is the U.S. National Phase of PCT Appln. No. PCT/EP2016/050940 filed Jan. 19, 2016, which claims priority to German Application No. 10 2015 201 099.6 filed Jan. 22, 2015, the disclosures of which are incorporated in their entirety by reference herein.

### BACKGROUND OF THE INVENTION

### 1. Field of the Invention

The invention relates to coating compositions based on crosslinkable compositions comprising silane-crosslinking prepolymers, silicone resins, and fillers, to methods for producing them, and to their use for coating, particularly of floors.

### 2. Description of the Related Art

Floors typically consist of a unit made up of base and utility layer constructed one over the other. The base is composed of a supporting layer, which usually consists of concrete, and, optionally, of an intermediate layer located on this supporting layer. The intermediate layer is generally screed or cast asphalt. Its purpose is to level the base or else to resolve a gradient. In the case of purely industrial floors, an intermediate layer is frequently omitted.

The actual surface utility layer is applied to this base. Its purpose is to protect the base from physical wear, but also from chemical exposure. At the same time it must meet the visual requirements of the floor coating.

Important properties for a floor coating, especially for basement floors, garage floors, and industrial floors, are therefore high surface tensile strength, which on areas utilized industrially ought to be at least 1.5 N/mm² and can be determined by means of simple tensile adhesion tests. Other properties as well, however, such as surface hardness (determinable by means of scratch tests), resistance to chemicals or else to moisture and frost, must be obtained. The coating, furthermore, ought to exhibit low soiling tendency, or the soiling in question ought to be removable without residue.

Surface coatings based on cementitious systems are widespread. Oftentimes, however, they possess the drawback of only moderate mechanical robustness. Moreover, they are not acid-resistant, display poorer adhesion than a synthetic-resin coating (typically <1.5 N/mm²), swell on exposure to moisture, and are devoid of adequate frost resistance. For many applications their visual qualities, too, are inadequate.

Significantly better properties are often possessed by coatings based on organic polymer systems, especially epoxy-resin coatings or polyurethane coatings. Here there exist broad product ranges for a wide variety of different applications, from coatings for purely industrial floors, through basement floors and storage-area floors, and onto visually high-quality coatings for hospitals, schools, nurseries, open-plan offices, entry halls, or else sales and exhibition spaces.

Drawbacks of these systems, however, are the toxicologically objectionable properties, of the liquid systems as yet uncrosslinked. Polyurethane coatings contain isocyanates including, in particular, residual amounts of isocyanate monomers having a critical toxicological classification. Epoxy resin systems, in contrast, contain the amine hardeners, which are likewise critically classified from a toxicological standpoint. Both systems exhibit sensitizing properties.

In addition, epoxy resin systems are often too hard and brittle and have very poor adhesion properties especially on moist substrates. Polyurethane systems, on the other hand, tend to form blisters on moist substrates, owing to the release of carbon dioxide during the reaction of isocyanate groups with water.

The majority of epoxy-resin coatings or polyurethane coatings, furthermore, are user-unfriendly two-component systems. Given the fact that in many cases there are other layers, such as primers, for example, that also have to be applied before the actual surface coating, the application of such systems is usually decidedly costly and inconvenient.

From the standpoint of toxicology in particular, silane-crosslinking coatings which cure through the condensation reactions of alkoxysilyl groups would be extremely desirable. This reaction occurs on contact with atmospheric moisture, and so such systems can usually be processed in one-component form. Moreover, the silyl groups are also able to react with a multiplicity of reactive OH groups in the base, and so the corresponding products often having strikingly good adhesion properties.

Particularly advantageous in relation to rapid curing of silane-crosslinking coatings is the use of what are called α-silane-terminated prepolymers, which possess reactive alkoxysilyl groups joined by a methylene spacer to an adjacent urethane unit. This class of compound is highly reactive and requires neither tin catalysts nor strong acids or bases to achieve high cure rates on contact with air. Commercially available α-silane-terminated prepolymers are GENIOSIL® STP-E10 or GENIOSIL® STP-E30 from Wacker Chemie AG, Munich (DE).

In the past, however, it has not been possible, either on the basis of α-silane-crosslinking prepolymers or with conventional silane-crosslinking prepolymers, to provide systems which satisfy the very exacting mechanical requirements of a floor coating.

### SUMMARY OF THE INVENTION

The problems of the prior art previously discussed have been surprisingly and unexpectedly solved by the use of a coating system comprising a silanol-functional or alkoxy-functional, moisture curable polymer, a silicone resin having a high proportion of alkoxy groups, and inorganic fillers.

### DETAILED DESCRIPTION OF THE PREFERRED EMBODIMENTS

A subject of the invention are thus crosslinkable coating compositions comprising

(A) 100 parts by weight of compounds (A) of the formula

Y—[(CR¹₂)_{b}—SiRₐ(OR²)₃₋ₐ]ₓ (I),

where
Y is an x-valent polymer radical bonded via nitrogen, oxygen, sulfur or carbon,
R may be identical or different and is a monovalent, optionally substituted, SiC-bonded hydrocarbyl radical,
R¹ may be identical or different and is hydrogen atom or a monovalent, optionally substituted hydrocarbyl radical, which may be attached via nitrogen, phosphorus, oxygen, sulfur or carbonyl group to the carbon atom,
R² may be identical or different and is hydrogen atom or a monovalent, optionally substituted hydrocarbyl radical,
x is an integer from 1 to 10, preferably 1, 2 or 3, more preferably 1 or 2,
a may be identical or different and is 0, 1 or 2, preferably 0 or 1, and
b may be identical or different and is an integer from 1 to 10, preferably 1, 3 or 4, more preferably 1 or 3, more particularly 1,

(B) more than 10 parts by weight of silicone resins comprising units of the formula

R³_{c}(R⁴O)_{d}R⁵ₑSiO_{(4-c-d-e)/2} (II),

where
R³ may be identical or different and is hydrogen, a monovalent, SiC-bonded, optionally substituted aliphatic hydrocarbyl radical or a divalent, optionally substituted, aliphatic hydrocarbyl radical which bridges two units of the formula (II),
R⁴ may be identical or different and is hydrogen or a monovalent, optionally substituted hydrocarbyl radical,
R⁵ may be identical or different and is a monovalent, SiC-bonded, optionally substituted aromatic hydrocarbyl radical,
c is 0, 1, 2 or 3,
d is 0, 1, 2 or 3, preferably 0, 1 or 2, more preferably 0 or 1, and
e is 0, 1 or 2, preferably 0 or 1,

with the proviso that the sum of c+d+e is less than or equal to 3 and in at least 40% of the units of the formula (II) the sum c+e is 0 or 1, and

(C) more than 50 parts by weight of inorganic fillers, where component (C) consists at least to an extent of 5 wt % of particles having a particle size of 10 μm to 1 cm.

Examples of radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl, isooctyl, and 2,2,4-trimethylpentyl radicals; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl and methylcyclohexyl radicals; alkenyl radicals such as the vinyl, 1-propenyl, and 2-propenyl radicals; aryl radicals such as the phenyl, naphthyl, anthryl, and phenanthryl radicals; alkaryl radicals such as the o-, m-, and p-tolyl radicals, xylyl radicals, and ethylphenyl radicals; and aralkyl radicals such as the benzyl radical, and the α- and the β-phenylethyl radicals.

Examples of substituted radicals R are haloalkyl radicals such as the 3,3,3-trifluoro-n-propyl radical, the 2,2,2,2′,2′,2′-hexafluoroisopropyl radical, and the heptafluoroisopropyl radical, and haloaryl radicals such as the o-, m-, and p-chlorophenyl radicals.

Radical R preferably comprises monovalent hydrocarbyl radicals having 1 to 6 carbon atoms, optionally substituted by halogen atoms, and more preferably alkyl radicals having 1 or 2 carbon atoms, most preferably the methyl radical.

Examples of radicals R¹ are hydrogen, the radicals stated for R, and also optionally substituted hydrocarbyl radicals bonded to the carbon atom by a nitrogen, phosphorus, oxygen, sulfur, carbon, or carbonyl group. Radical R¹ preferably comprises hydrogen or hydrocarbyl radicals having 1 to 20 carbon atoms, more preferably hydrogen.

Examples of radical R² are hydrogen or the examples stated for radical R. Radical R² preferably comprises hydrogen or alkyl radicals having 1 to 10 carbon atoms and optionally substituted by halogen atoms, more preferably alkyl radicals having 1 to 4 carbon atoms, most preferably the methyl or ethyl radical.

Polymers on which the polymer radical Y is based are understood for the purposes of the present invention to be all polymers in which at least 50%, preferably at least 70%, more preferably at least 90% of all bonds in the main chain are carbon-carbon, carbon-nitrogen or carbon-oxygen bonds.

Examples of polymer radicals Y are polyester, polyether, polyurethane, polyalkylene, and polyacrylate radicals.

Polymer radical Y preferably comprises organic polymer radicals which contain, as their polymer chain, polyoxyalkylenes such as polyoxyethylene, polyoxypropylene, polyoxybutylene, polyoxy-tetramethylene, polyoxyethylene-polyoxypropylene copolymer and polyoxypropylene-polyoxybutylene copolymer; hydrocarbon polymers such as polyisobutylene copolymers of polyisobutylene with isoprene; polychloroprenes; polyisoprenes; polyurethanes; polyesters; polyamides; polyacrylates; polymethacrylates; vinyl polymers, and polycarbonates, and which are bonded preferably via —O—C(═O)—NH—, —NH—C(═O)O—, —NH—C(═O)—NH—, —NR′—C(═O)—NH—, NH—C(═O)—NR′—, —NH—C(═O)—, —C(═O)—NH—, —C(═O)—O—, —O—C(═O)—, —O—C(═O)—O—, —S—C(═O)—NH—, —NH—C(═O)—S—, —C(═O)—S—, —S—C(═O)—, —S—C(═O)—S—, —C(═O)—, —S—, —O—, —NR′— to the group or groups —[(CR¹₂)_{b}—SiRₐ(OR²)₃₋ₐ], where R′ may be identical or different and has the definition of R or is a group —CH(COOR″)—CH₂—COOR″, in which R″ may be identical or different and has the definition of R.

Radical R′ preferably comprises a group —CH(COOR″)—CH₂—COOR″ or an optionally substituted hydrocarbyl radical having 1 to 20 carbon atoms, more preferably a linear, branched or cyclic alkyl group having 1 to 20 carbon atoms, or an aryl group which has 6 to 20 carbon atoms and is optionally substituted by halogen atoms.

Examples of radicals R′ are cyclohexyl, cyclopentyl, n- and isopropyl, n-, iso-, and t-butyl, the various stereoisomers of the pentyl radical, hexyl radical or heptyl radical, and also the phenyl radical.

The radicals R″ are preferably alkyl groups having 1 to 10 carbon atoms, more preferably methyl, ethyl or propyl radicals.

With particular preference radical Y in formula (I) comprises polyurethane radicals or polyoxyalkylene radicals, more particularly polyoxypropylene radicals.

Component (A) may have the groups —[(CR¹₂)_{b}—SiRₐ(OR²)₃₋ₐ], attached in the manner described, at any desired locations in the polymer, such as within the chain and/or terminally.

With particular preference, radical Y in formula (I) comprises polyurethane radicals or polyoxyalkylene radicals to which the groups —[(CR¹₂)_{b}—SiRₐ(OR²)₃₋ₐ] are attached terminally. These radicals are preferably linear or have 1 to 3 branching points. With particular preference they are linear.

The polyurethane radicals Y are preferably those whose chain ends are bonded via —NH—C(═O)O—, —NH—C(═O)—NH—, —NR′—C(═O)—NH— or —NH—C(═O)—NR′—, more particularly via —O—C(═O)—NH— or —NH—C(═O)—NR′—, to the group or groups —[(CR¹₂)_{b}—SiRₐ(OR²)₃₋ₐ], with all of the radicals and indices having one of the definitions stated above. These polyurethane radicals Y are preferably preparable from linear or branched polyoxyalkylenes, more particularly from polypropylene glycols, and di- or polyisocyanates. The radicals Y here preferably have average molar masses Mₙ (number average) of 400 to 30,000 g/mol, preferably of 4000 to 20,000 g/mol. Suitable processes for preparing such a component (A) and also examples of component (A) itself are described in publications including EP 1 093 482 B1 (paragraphs [0014]-[0023], [0039]-[0055] and also inventive example 1 and comparative example 1) or EP 1 641 854 B1 (paragraphs [0014]-[0035], inventive examples 4 and 6 and comparative examples 1 and 2), which are considered part of the disclosure content of the present application.

In the context of the present invention, the number-average molar mass Mₙ is determined by means of Size Exclusion Chromatography (SEC) against a polystyrene standard, in THF, at 60° C., flow rate 1.2 ml/min with detection by RI (refractive index detector) on a Styragel HR3-HR4-HR5-HR5 column set from Waters Corp. USA, with an injection volume of 100 μl.

The polyoxyalkylene radicals Y are preferably linear or branched polyoxyalkylene radicals, more preferably polyoxypropylene radicals, whose chain ends are preferably bonded via —O—C(═O)—NH— or —O— to the group or groups —[(CR¹₂)_{b}—SiRₐ(OR²)₃₋ₐ], the radicals and indices having one of the definitions stated above. Preferably here at least 85%, more preferably at least 90%, and most preferably at least 95% of all chain ends are bonded via —O—C(═O)—NH— to the group —[(CR¹₂)_{b}—SiRₐ(OR²)₃₋ₐ]. The polyoxyalkylene radicals Y preferably have average molar masses Mₙ of 4000 to 30,000 g/mol, more preferably of 8000 to 20,000 g/mol. Suitable processes for preparing such a component (A) and also examples of component (A) itself are described in publications including EP 1 535 940 B1 (paragraphs [0005]-[0025] and also inventive examples 1-3 and comparative example 1-4) or EP 1 896 523 B1 (paragraphs [0008]-[0047]), which are considered part of the disclosure content of the present application.

The end groups of the compounds (A) for inventive use are preferably groups of the general formulae

—NH—C(═O)—NR′—(CR¹₂)_{b}—SiRₐ(OR²)₃₋ₐ (IV),

—O—C(═O)—NH—(CR¹₂)_{b}—SiRₐ(OR²)₃₋ₐ (V) or

—O—(CR¹₂)_{b}—SiRₐ(OR²)₃₋ₐ (VI),

where the radicals and indices have one of the definitions stated for them above.

Where the compounds (A) are polyurethanes, as is preferred, they preferably have one or more of the end groups

—NH—C(═O)—NR′—(CH₂)₃—Si(OCH₃)₃,

—NH—C(═O)—NR′—(CH₂)₃—Si(OC₂H₅)₃,

—O—C(═O)—NH—(CH₂)₃—Si(OCH₃)₃ or

—O—C(═O)—NH—(CH₂)₃—Si(OC₂H₅)₃,

where R′ has the definition stated above.

Where the compounds (A) are polypropylene glycols, as is particularly preferred, they preferably have one or more of the end groups

—O—(CH₂)₃—Si(CH₃)(OCH₃)₂,

—O—(CH₂)₃—Si(OCH₃)₃,

—O—C(═O)—NH—(CH₂)₃—Si(OC₂H₅)₃,

—O—C(═O)—NH—CH₂—Si(CH₃)(OC₂H₅)₂,

—O—C(═O)—NH—CH₂—Si(OCH₃)₃,

—O—C(═O)—NH—CH₂—Si(CH₃)(OCH₃)₂ or

—O—C(═O)—NH—(CH₂)₃—Si(OCH₃)₃,

where the two last-mentioned end groups are particularly preferred.

The average molecular weights Mₙ of the compounds (A) are preferably at least 400 g/mol, more preferably at least 4000 g/mol, most preferably at least 10,000 g/mol, and preferably not more than 30,000 g/mol, and most preferably not more than 20,000 g/mol, and most preferably not more than 19,000 g/mol.

The viscosity of the compounds (A) is preferably at least 0.2 Pas, more preferably at least 1 Pas, and most preferably at least 5 Pas, and preferably at most 700 Pas, more preferably at most 100 Pas, in each case measured at 23° C.

The viscosity is determined for the purposes of the present invention after conditioning at 23° C., using a DV 3 P rotary viscometer from A. Paar (Brookfieldsystem) with spindle 5 at 2.5 rpm in accordance with ISO 2555.

The compounds (A) used inventively are commercial products or can be prepared by methods common within chemistry.

The polymers (A) may be prepared by known processes, such as addition reactions, as for example hydrosilylation, Michael addition, Diels-Alder addition or reaction between isocyanate-functional compounds with compounds containing isocyanate-reactive groups.

Component (A) may contain only one kind of compound of the formula (I), and also mixtures of different kinds of compounds of the formula (I). This component (A) may contain exclusively compounds of the formula (I) in which more than 90%, preferably more than 95%, and more preferably more than 98% of all silyl groups bonded to the radical Y are identical. In that case, however, it is also possible to use a component (A) which includes, at least in part, compounds of the formula (I) in which different silyl groups are bonded to a radical Y. Furthermore, as component (A), it is also possible to use mixtures of different compounds of the formula (I) in which in total at least 2 different kinds of silyl groups bonded to radicals Y are present, but all silyl groups bonded to any one radical Y are identical.

The compositions of the invention preferably comprise compounds (A) in concentrations of at most 40 wt %, more preferably at most 30 wt %, and preferably at least 3 wt %, more preferably at least 5 wt %.

Based on 100 parts by weight of component (A), the compositions of the invention preferably comprise at least 30 parts by weight, more preferably at least 60 parts by weight, and most preferably at least 100 parts by weight of component (B). Based on 100 parts by weight of component (A), the compositions of the invention contain preferably at most 1000 parts by weight, more preferably at most 500 parts by weight, and most preferably at most 300 parts by weight of component (B).

Component (B) consists preferably to an extent of at least 90 wt % of units of the formula (II). More preferably component (B) consists exclusively of units of the formula (II).

Examples of radicals R³ are the aliphatic radicals stated above for R. However, radical R³ may also comprise divalent aliphatic radicals which join two silyl groups of the formula (II) to one another, such as alkylene radicals having 1 to 10 carbon atoms, for instance, methylene, ethylene, propylene or butylene radicals. A particularly common example of a divalent aliphatic radical is the ethylene radical.

Preferably, however, radical R³ comprises monovalent, SiC-bonded, aliphatic hydrocarbyl radicals which have 1 to 18 carbon atoms and are optionally substituted by halogen atoms, and more preferably comprises aliphatic hydrocarbyl radicals having 1 to 8 carbon atoms, such as, for instance, methyl, ethyl, propyl, butyl, n-octyl or isooctyl radicals, more preferably the isooctyl or methyl radical, the methyl radical being especially preferred.

Examples of radical R⁴ are hydrogen or the examples stated for radical R.

Radical R⁴ preferably comprises hydrogen or alkyl radicals having 1 to 10 carbon atoms, optionally substituted by halogen atoms, and more preferably comprises alkyl radicals having 1 to 4 carbon atoms, more particularly the methyl and ethyl radical.

Examples of radicals R⁵ are the aromatic radicals stated above for R.

Radical R⁵ preferably comprises SiC-bonded aromatic hydrocarbyl radicals having 6 to 18 carbon atoms and being optionally substituted by halogen atoms, such as, for example, ethylphenyl, tolyl, xylyl, chlorophenyl, naphthyl or styryl radicals, more preferably the phenyl radical.

Preferred for use as component (B) are silicone resins in which at least 90% of all radicals R³ are n-octyl, isooctyl or methyl radicals, and more preferably at least 90% of all radicals R³ are methyl radicals.

Preferred for use as component (B) are silicone resins in which at least 90% of all radicals R⁴ are methyl, ethyl, propyl or isopropyl radicals.

Preferred for use as component (B) are silicone resins in which at least 90% of all radicals R⁵ are phenyl radicals.

Preference in accordance with the invention is given to using silicone resins (B) which have at least 20%, more preferably at least 40%, of units of the formula (II) in which c is 0, based in each case on the total number of units of the formula (II).

Preference is given to using silicone resins (B) which, based in each case on the total number of units of the formula (II), have at least 70%, more preferably at least 80%, of units of the formula (II) in which d has a value of 0 or 1.

Preference is given to the use as component (B) of silicone resins which, based in each case on the total number of units of the formula (II), have at least 20%, more preferably at least 40%, and most preferably at least 50% of units of the formula (II) in which e has a value of 1.

One particular embodiment of the invention uses silicone resins (B) which have exclusively units of the formula (II) in which e is 1.

In one version of the invention, particularly preferably, silicone resins are used as component (B) that have, in each case based on the total number of units of the formula (II), at least 20%, more preferably at least 40%, more particularly at least 50% of units of the formula (II) in which e has a value of 1 and c has a value of 0.

Preferred for use as component (B) are silicone resins which, based in each case on the total number of units of the formula (II), have at least 50%, preferably at least 60%, more preferably at least 70% of units of the formula (II) in which the sum c+e is 0 or 1.

Examples of the silicone resins (B) used inventively are organopolysiloxane resins which consist substantially, preferably exclusively, of units selected from (Q) units of the formulae SiO_{4/2}, Si(OR⁴)O_{3/2}, Si(OR⁴)₂O_{2/2}, and Si(OR⁴)₃O_{1/2}, (T) units of the formulae PhSiO_{3/2}, PhSi(OR⁴)O_{2/2}, PhSi(OR⁴)₂O_{1/2}, MeSiO_{3/2}, MeSi(OR⁴)O_{2/2}, MeSi(OR⁴)₂O_{1/2}, i-OctSiO_{3/2}, i-OctSi(OR⁴)O_{2/2}, i-OctSi(OR⁴)₂O_{1/2}, n-OctSiO_{3/2}, n-OctSi(OR⁴)O_{2/2}, and n-OctSi(OR⁴)₂O_{1/2}, (D) units of the formulae Me₂SiO_{2/2} and Me₂Si(OR⁴)O_{1/2}, and (M) units of the formula Me₃SiO_{1/2}, where Me is methyl radical, Ph is phenyl radical, n-Oct is n-octyl radical, and i-Oct is isooctyl radical, and R⁴ is hydrogen or an alkyl radical having 1 to 10 carbon atoms, optionally substituted by halogen atoms, and more preferably is an unsubstituted alkyl radical having 1 to 4 carbon atoms, where the resin preferably has 0-2 mol of (Q) units, 0-2 mol of (D) units, and 0-2 mol of (M) units per mole of (T) units.

Preferred examples of the silicone resins (B) used inventively are organopolysiloxane resins which consist substantially, preferably exclusively, of units selected from T units of the formulae PhSiO_{3/2}, PhSi(OR⁴)O_{2/2}, and PhSi(OR⁴)₂O_{1/2} and also T units of the formulae MeSiO_{3/2}, MeSi(OR⁴)O_{2/2}, and MeSi(OR⁴)₂O_{1/2}, where Me is methyl radical, Ph is phenyl radical, and R⁴ is hydrogen or an alkyl radical having 1 to 10 carbon atoms, optionally substituted by halogen atoms.

Further preferred examples of the silicone resins (B) used inventively are organopolysiloxane resins which consist substantially, preferably exclusively, of units selected from T units of the formulae PhSiO_{3/2}, PhSi(OR⁴)O_{2/2}, and PhSi(OR⁴)₂O_{1/2}, T units of the formulae MeSiO_{3/2}, MeSi(OR⁴)O_{2/2}, and MeSi(OR⁴)₂O_{1/2}, and D units of the formulae Me₂SiO_{2/2} and Me₂Si(OR⁴)O_{1/2}, where Me is methyl radical, Ph is phenyl radical, and R⁴ is hydrogen or an alkyl radical having 1 to 10 carbon atoms, optionally substituted by halogen atoms, and preferably is an unsubstituted alkyl radical having 1 to 4 carbon atoms, with a molar ratio of phenylsilicone units to methylsilicone units of 0.5 to 4.0. The amount of D units in these silicone resins is preferably below 10 wt %.

Particularly preferred examples of the silicone resins (B) used inventively are organopolysiloxane resins which consist to an extent of 80%, preferably 90%, and more particularly, exclusively, of T units of the formulae PhSiO_{3/2}, PhSi(OR⁴)O_{2/2}, and PhSi(OR⁴)₂O_{1/2}, where Ph is the phenyl radical and R⁴ is hydrogen or an alkyl radical having 1 to 10 carbon atoms optionally substituted by halogen atoms, and preferably is an unsubstituted alkyl radical having 1 to 4 carbon atoms, based in each case on the total number of units.

The silicone resins (B) used inventively preferably possess an average molar mass (number average) Mₙ of at least 400 g/mol and more preferably of at least 600 g/mol. The average molar mass Mₙ is preferably at most 400,000 g/mol, more preferably at most 10,000 g/mol, and most preferably at most 3000 g/mol.

The silicone resins (B) used inventively may be either solid or liquid at 23° C. and 1000 hPa; silicone resins (B) are preferably liquid. At 23° C. the silicone resins (B) preferably possess a viscosity of 10 to 100 000 mPas, preferably 50 to 50,000 mPas, and most preferably of 100 to 20,000 mPas.

The silicone resins (B) used inventively preferably possess a polydispersity (M_{w}/Mₙ) of not more than 5, more preferably not more than 3.

The mass-average molar mass M_{w}, like the number-average molar masses Mₙ, is determined here by means of Size Exclusion Chromatography (SEC) against polystyrene standards, in THF, at 60° C., flow rate 1.2 ml/min, with detection by RI (refractive index detector) on a Styragel HR3-HR4-HR5-HR5 column set from Waters Corp. USA, using an injection volume of 100 μl.

The silicone resins (B) may be used either in pure form or in the form of a mixture with a suitable solvent (BL).

Solvents (BL) which can be used here are all compounds which are not reactive toward components (A) and (B) at room temperature and have a boiling point <250° C. at 1013 mbar.

Examples of optionally employed solvents (BL) are ethers such as diethyl ether, methyl tert-butyl ether, ether derivatives of glycol, and THF; esters such as ethyl acetate, butyl acetate, and glycol esters; aliphatic hydrocarbons such as pentane, cyclopentane, hexane, cyclohexane, heptane, octane, or longer-chain branched and unbranched alkanes; ketones such as acetone and methyl ethyl ketone; aromatics such as toluene, xylene, ethylbenzene, and chlorobenzene; and alcohols such as methanol, ethanol, glycol, propanol, isopropanol, glycerol, butanol, isobutanol, and tert-butanol, for example.

Many resins (B) available commercially, such as the resins SILRES® SY 231, SILRES® IC 231, SILRES® IC 368, SILRES® IC 678 or SILRES® BS 1268 from Wacker Chemie AG, Munich, Germany, are indeed liquid at 23° C. and 1013 hPa, but nevertheless, as an artifact of their production, include small amounts of solvents (BL), particularly toluene. For instance, the aforementioned resins contain about 0.1 wt % of toluene, based on the total weight of the resin.

Toluene-free resins (B) are likewise available commercially, examples being GENIOSIL® LX 678 or GENIOSIL® LX 368 from Wacker Chemie AG, Munich, Germany.

Silicone resins used as component (B) in one preferred embodiment of the invention are those containing less than 0.1 wt %, preferably less than 0.05 wt %, more preferably less than 0.02 wt %, and most preferably less than 0.01 wt % of aromatic solvents (BL).

Silicone resins (B) used as component (B) in one particularly preferred embodiment of the invention are those which, with the exception of the alcohols R⁴OH, contain less than 0.1 wt %, preferably less than 0.05 wt %, more preferably less than 0.02 wt %, and most preferably less than 0.01 wt % of solvents (BL), where R⁴ has the definition stated above.

Silicone resins used as component (B) in one especially preferred embodiment of the invention are those which, apart from alcohols R⁴OH, contain no solvents (BL) at all, where R⁴ has the definition stated above, and alcohols R⁴OH are present in amounts of preferably not more than 5 wt %, more preferably 0 to 1 wt %, generally as an artifact of their production.

The silicone resins (B) used inventively are commercial products or can be prepared by methods which are common within silicon chemistry.

The inorganic fillers (C) used in the compositions of the invention may in principle be any desired inorganic fillers known to date, and may have been treated with organic or silicon-organic substances.

Examples of fillers (C) are nonreinforcing fillers, these being fillers preferably having a BET surface area of up to 50 m²/g, such as quartz, diatomaceous earth, calcium silicate, zirconium silicate, talc, kaolin, zeolites, metal oxide powders, such as aluminum oxides, titanium oxides, iron oxides or zinc oxides and/or mixed oxides thereof, barium sulfate, calcium carbonate, gypsum, silicon nitride, silicon carbide, boron nitride, glass powders; reinforcing fillers, these being fillers having a BET surface area of more than 50 m²/g, such as pyrogenically produced silica, precipitated silica, precipitated chalk, carbon black, aluminum trihydroxide, and mixed silicon aluminum oxides of high BET surface area. The stated fillers may have been rendered hydrophobic, by means for example of treatment with organosilanes and/or organosiloxanes or with stearic acid, or by etherification of hydroxyl groups to alkoxy groups.

Component (C) used inventively preferably comprises fillers containing aluminum oxide and/or fillers containing silicon oxide.

The fillers (C) used inventively preferably comprise silicon dioxide, aluminum oxide and/or mixed silicon aluminum oxides, more particularly silica sand and/or finely ground quartz. Component (C) here may either contain exclusively silica sand and/or finely ground quartz, or else may constitute mixtures of silica sand and/or finely ground quartz with other fillers such as talc or chalk, for example.

Employed as component (C) may be only one type of filler or else two or more types of filler. The materials in question may be either different materials, such as a mixture of sand and talc or else of sand and chalk, for example, and also mixtures of identical materials which, however, differ in their particle sizes and/or particle size compositions, examples being mixtures of coarse-grained silica sand with finely divided quartz flour. Preference is given to using mixtures of a plurality of fillers.

Preferably component (C) consists to an extent of at least 40 wt %, more preferably at least 60 wt %, and most preferably at least 80 wt %, of silicon dioxide, aluminum oxide and/or mixed silicon aluminum oxides.

Preferably component (C) consists to an extent of at least 40 wt %, more preferably at least 60 wt %, and most preferably at least 80 wt %, of silica sand and/or finely ground quartz.

As compared with conventional fillers of the kind used in typical silane-crosslinking adhesives and sealants (e.g., chalk, aluminum trihydroxide, talc, and precipitated or fumed silica), the fillers preferably used as component (C), silicon oxide, aluminum oxide and/or mixed silicon aluminum oxides, possess comparatively large average particle sizes.

The inorganic fillers (C) used inventively preferably have average particle sizes of 0.01 μm to 1 cm, more preferably of 0.1 μm to 2000 μm. In the case of fibrous fillers, the longest dimension corresponds to the particle size.

Preferred for use as fillers (C) are silicon oxide, aluminum oxide and/or mixed silicon aluminum oxides, more preferably silica sand and/or finely ground quartz, having average particle sizes of 1 μm to 1 cm, more preferably of 5 μm to 2000 μm, more particularly of 10 μm to 1000 μm. Component (C) consists preferably to an extent of at least 40 wt %, more preferably at least 60 wt %, and most preferably at least 80 wt % of silicon oxide, aluminum oxide and/or mixed silicon aluminum oxides with corresponding average particle sizes.

In the compositions of the invention, component (C) consists to an extent of at least 5 wt % of particles preferably having particle sizes of 20 μm to 1 cm, more preferably of 30 μm to 2000 μm, and most preferably of 40 μm to 2000 μm.

In the compositions of the invention, component (C) consists preferably, to an extent of at least 10 wt %, more preferably at least 20 wt %, yet more preferably at least 30 wt %, and most preferably of 50 to 100 wt %, of particles having particle sizes of 10 μm to 1 cm.

Component (C) preferably possesses a content of at least 10 wt % of particles having particle sizes of 20 μm to 2000 μm, more preferably 30 μm to 1000 μm, and most preferably 40 μm to 1000 μm.

In one particularly preferred embodiment of the invention, component (C) preferably consists to an extent of at least 10 wt %, more preferably at least 20 wt %, yet more preferably at least 30 wt %, and most preferably of 50 to 100 wt %, of particles having particle sizes of 60 μm to 1 cm.

The total amount of all fillers (C) used preferably possesses a broad particle size distribution. Preferably component (C) consists to an extent of at least 5 wt %, more preferably at least 10 wt %, and most preferably 10 to 50 wt %, of particles having a particle size which is smaller by a factor of at least 5 than the average particle size of the total amount of filler in component (C), with component (C) consisting at least to an extent of 5 wt % of particles having a particle size of 10 μm to 1 cm. Furthermore, component (C) preferably consists to an extent of at least 5 wt %, more preferably at least 10 wt %, most preferably 10 to 50 wt %, of particles having a particle size which is greater by a factor of at least 5 than the average particle diameter of the total amount of filler in component (C), with component (C) consisting at least to an extent of 5 wt % of particles having a particle size of 10 μm to 1 cm.

The particle size distribution of particles >500 μm is analyzed preferably using an ALPINE e200 LS air jet sieve, with analytical sieves meeting the requirements of DIN ISO 3310-1. Analysis of particle size distribution in the range from 0.01 to 500 μm is carried out preferably with a CILAS 1064 PARTICLE SIZE ANALYZER.

The weight fractions of particles having a particular particle size are determined here preferably by sieving, using sieves having the respective mesh size. The sieve residue corresponds to the respective fraction of particles having a particle size which is greater than the mesh size used in that case.

The average particle sizes here are determined by means of what are called grading curves, i.e., by sieving the filler through sieves differing in sieve mesh size. For each sieving operation, weighing the sieve residue gives the content of particles having an average diameter greater than the sieve mesh size used in that case. By using sieves differing in their mesh sizes, it is possible, accordingly, to determine the particle size distribution reliably. Such methods are familiar to the skilled person; grading curves and average particle sizes are generally determined by the supplier of the fillers in question and are stated in the corresponding product data sheets. The average particle size here always represents the arithmetic mean of the particle size distributions determined by means of grading curves.

The coating compositions of the invention preferably comprise 75 to 2000 parts by weight, more preferably 100 to 1000 parts by weight, and most preferably 200 to 700 parts by weight, of fillers (C), based in each case on 100 parts by weight of constituent (A).

In addition to the components (A), (B), and (C), the compositions of the invention may comprise all further substances which are useful in crosslinkable compositions and which are different from components (A), (B), and (C)—such as, for example, nitrogen-containing organosilicon compounds (D), catalysts (E), adhesion promoters (F), water scavengers (G), additives (H), and adjuvants (I).

Component (D) preferably comprises organosilicon compounds comprising units of the formula

DₕSi(OR⁷)_{g}R⁶_{f}O_{(4-f-g-h)/2} (III),

in which

R⁶ may be identical or different and is a monovalent, optionally substituted, SiC-bonded, nitrogen-free organic radical,

R⁷ may be identical or different and is hydrogen or an optionally substituted hydrocarbyl radical,

D may be identical or different and is a monovalent, SiC-bonded radical having at least one nitrogen atom not bonded to a carbonyl group (C═O),

f is 0, 1, 2 or 3, preferably 1,

g is 0, 1, 2 or 3, preferably 1, 2 or 3, more preferably 1 or 3, and

h is 0, 1, 2, 3 or 4, preferably 1,

with the proviso that the sum of f+g+h is less than or equal to 4 and there is at least one radical D per molecule.

The organosilicon compounds (D) used optionally in accordance with the invention may be either silanes, i.e., compounds of the formula (III) with f+g+h=4, or siloxanes, i.e., compounds containing units of the formula (III) with f+g+h≦3, and are preferably silanes.

Examples of radical R⁶ are the examples stated for R.

Radical R⁶ preferably comprises hydrocarbyl radicals having 1 to 18 carbon atoms optionally substituted by halogen atoms, more preferably hydrocarbyl radicals having 1 to 5 carbon atoms, and most preferably the methyl radical.

Examples of optionally substituted hydrocarbyl radicals R⁷ are the examples stated for radical R.

The radicals R⁷ are preferably hydrogen and hydrocarbyl radicals having 1 to 18 carbon atoms optionally substituted by halogen atoms, and more preferably are hydrogen and hydrocarbyl radicals having 1 to 10 carbon atoms, and most preferably are methyl and ethyl radicals.

Examples of radicals D are radicals of the formulae H₂N(CH₂)₃—, H₂N(CH₂)₂NH(CH₂)₃—, H₂N(CH₂)₂NH(CH₂)₂NH(CH₂)₃—, H₃CNH(CH₂)₃—, C₂H₅NH(CH₂)₃—, C₃H₇NH(CH₂)₃—, C₄H₉NH(CH₂)₃—, C₅H₁₁NH(CH₂)₃—, C₆H₁₃NH(CH₂)₃—, C₇H₁₅NH(CH₂)₃—, H₂N(CH₂)₄—, H₂N—CH₂—CH(CH₃)—CH₂—, H₂N(CH₂)₅—, cyclo-C₅H₉NH(CH₂)₃—, cyclo-C₆H₁₁NH(CH₂)₃—, phenyl-NH(CH₂)₃—, (CH₃)₂N(CH₂)₃—, (C₂H₅)₂N(CH₂)₃—, (C₃H₇)₂N(CH₂)₃—, (C₄H₉)₂N(CH₂)₃—, (C₅H₁₁)₂N(CH₂)₃—, (C₆H₁₃)₂N(CH₂)₃—, (C₇H₁₅)₂N(CH₂)₃—, H₂N(CH₂)—, H₂N(CH₂)₂NH(CH₂)—, H₂N(CH₂)₂NH(CH₂)₂NH(CH₂)—, H₃CNH(CH₂)—, C₂H₅NH(CH₂)—, C₃H₇NH(CH₂)—, C₄H₉NH(CH₂)—, C₅H₁₁NH(CH₂)—, C₆H₂₃NH(CH₂)—, C₇H₂₅NH(CH₂)—, cyclo-C₅H₉NH(CH₂)—, cyclo-C₆H₁₁NH(CH₂)—, phenyl-NH(CH₂)—, (CH₃)₂N(CH₂)—, (C₂H₅)₂N(CH₂)—, (C₃H₇)₂N(CH₂)—, (C₄H₉)₂N(CH₂)—, (C₅H₁₁)₂N(CH₂)—, (C₆H₁₃)₂N(CH₂)—, (C₇H₁₅)₂N(CH₂)—, (CH₃O)₃Si(CH₂)₃NH(CH₂)₃—, (C₂H₅O)₃Si(CH₂)₃NH(CH₂)₃—, (CH₃O)₂(CH₃)Si(CH₂)₃NH(CH₂)₃—, and (C₂H₅O)₂(CH₃)Si(CH₂)₃NH(CH₂)₃—, and also reaction products of the abovementioned primary amino groups with compounds which contain epoxide groups or double bonds that are reactive toward primary amino groups.

Radical D preferably comprises the H₂N(CH₂)₃—, H₂N(CH₂)₂NH(CH₂)₃— or cyclo-C₆H₁₁NH(CH₂)₃— radical.

Examples of the silanes of the formula (III) employed optionally in accordance with the invention are H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, H₂N(CH₂)₂NH(CH₂)₃—Si(OC₂H₅)₂CH₃, H₂N(CH₂)₂NH(CH₂)₃—Si(OH)₃, H₂N(CH₂)₂NH(CH₂)₃—Si(OH)₂CH₃, H₂N(CH₂)₂NH(CH₂)₂NH(CH₂)₃—Si(OCH₃)₃, H₂N(CH₂)₂NH(CH₂)₂NH(CH₂)₃—Si(OC₂H₅)₃, cyclo-C₆H₁₁NH(CH₂)₃—Si(OCH₃)₃, cyclo-C₆H₁₁NH(CH₂)₃—Si(OC₂H₅)₃, cyclo-C₆H₁₁NH(CH₂)₃—Si(OCH₃)₂CH₃, cyclo-C₆H₁₁NH(CH₂)₃—Si(OC₂H₅)₂CH₃, cyclo-C₆H₁₁NH(CH₂)₃—Si(OH)₃, cyclo-C₆H₁₁NH(CH₂)₃—Si(OH)₂CH₃, phenyl-NH(CH₂)₃—Si(OCH₃)₃, phenyl-NH(CH₂)₃—Si(OC₂H₅)₃, phenyl-NH(CH₂)₃—Si(OCH₃)₂CH₃, phenyl-NH(CH₂)₃—Si(OC₂H₅)₂CH₃, phenyl-NH(CH₂)₃—Si(OH)₃, phenyl-NH(CH₂)₃—Si(OH)₂CH₃, HN((CH₂)₃—Si(OCH₃)₃)₂, HN((CH₂)₃—Si(OC₂H₅)₃)₂HN((CH₂)₃—Si(OCH₃)₂CH₃)₂, HN((CH₂)₃—Si(OC₂H₅)₂CH₃)₂, cyclo-C₆H₁₁NH(CH₂)—Si(OCH₃)₃, cyclo-C₆H₁₁NH(CH₂)—Si(OC₂H₅)₃, cyclo-C₆H₁₁NH(CH₂)—Si(OCH₃)₂CH₃, cyclo-C₆H₁₁NH(CH₂)—Si(OC₂H₅)₂CH₃, cyclo-C₆H₁₁NH(CH₂)—Si(OH)₃, cyclo-C₆H₁₁NH(CH₂)—Si(OH)₂CH₃, phenyl-NH(CH₂)—Si(OCH₃)₃, phenyl-NH(CH₂)—Si(OC₂H₅)₃, phenyl-NH(CH₂)—Si(OCH₃)₂CH₃, Phenyl-NH(CH₂)—Si(OC₂H₅)₂CH₃, Phenyl-NH(CH₂)—Si(OH)₃, and phenyl-NH(CH₂)—Si(OH)₂CH₃, and also their partial hydrolysates, particular preference being given to H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OCH₃)₂CH₃, H₂N(CH₂)₂NH(CH₂)₃—Si(OC₂H₅)₃, H₂N(CH₂)₂NH(CH₂)₃—Si(OC₂H₅)₂CH₃ or in each case their partial hydrolysates.

The organosilicon compounds (D) used optionally in accordance with the invention may also take on the function of a curing catalyst or curing cocatalyst in the compositions of the invention.

Furthermore, the organosilicon compounds (D) used optionally in accordance with the invention may act as adhesion promoters and/or as water scavengers.

The organosilicon compounds (D) used optionally in accordance with the invention are commercial products and/or are producible by methods which are common within chemistry.

If the compositions of the invention do include component (D), the amounts are preferably 0.1 to 40 parts by weight, more preferably 0.2 to 30 parts by weight, and most preferably 0.5 to 15 parts by weight, based in each case on 100 parts by weight of component (A). The compositions of the invention preferably do comprise component (D).

The catalysts (E) optionally employed in the compositions of the invention may be any desired catalysts useful for compositions which cure by silane condensation.

Examples of metal-containing curing catalysts (E) are organic titanium compounds and tin compounds, examples being titanic esters such as tetrabutyl titanate, tetrapropyl titanate, tetraisopropyl titanate, and titanium tetraacetylacetonate; tin compounds such as dibutyltin dilaurate, dibutyltin maleate, dibutyltin diacetate, dibutyltin dioctanoate, dibutyltin acetylacetonate, dibutyltin oxides, and corresponding dioctyltin compounds.

Examples of metal-free curing catalysts (E) are basic compounds, such as triethylamine, tributylamine, 1,4-diazabicyclo[2.2.2]octane, 1,5-diazabicyclo[4.3.0]non-5-ene, 1,8-diazabicyclo[5.4.0]undec-7-ene, N,N-bis(N,N-dimethyl-2-amino-ethyl)methylamine, N,N-dimethylcyclohexylamine, N,N-dimethyl-phenylamine, and N-ethylmorpholinine, or salts of carboxylic acids, such as sodium lactate.

Likewise as catalyst (E) it is possible to use acidic compounds such as phosphoric acid and its partially esterified derivatives, toluenesulfonic acid, sulfuric acid, nitric acid, or else organic carboxylic acids, e.g., acetic acid and benzoic acid.

If the compositions of the invention do include catalyst (E), the amounts are preferably 0.01 to 20 parts by weight, more preferably 0.05 to 5 parts by weight, based in each case on 100 parts by weight of constituent (A).

In one embodiment of the invention, the catalysts (E) optionally employed are metal-containing curing catalysts, preferably tin-containing catalysts. This embodiment of the invention is especially preferred when component (A) consists wholly or at least partially, i.e., to an extent of at least 90 wt %, preferably at least 95 wt %, of compounds of the formula (I) in which b is other than 1.

In the compositions of the invention, it is possible with preference to do without metal-containing catalysts (E), and especially without tin-containing catalysts, if component (A) consists wholly or at least partially, i.e., to an extent of at least 10 wt %, preferably at least 20 wt %, of compounds of the formula (I) in which b is 1 and R¹ is a hydrogen atom. This embodiment of the invention, without metal-containing catalysts and more particularly without tin-containing catalysts, is particularly preferred.

The adhesion promoters (F) employed optionally in the compositions of the invention may be any desired adhesion promoters useful for systems which cure by silane condensation.

Examples of adhesion promoters (F) are epoxy silanes such as 3-glycidoxypropyltrimethoxysilanes, 3-glycidoxypropylmethyldimethoxysilane, 3-glycidoxypropyltriethoxysilane or 3-glycidoxypropylmethyldiethoxysilane, 2-(3-triethoxysilylpropyl)maleic anhydride, N-(3-trimethoxysilylpropyl)urea, N-(3-triethoxysilylpropyl)urea, N-(trimethoxysilylmethyl) urea, N-(methyldimethoxysilyl-methyl)urea, N-(3-triethoxysilylmethyl)urea, N-(3-methyldiethoxysilylmethyl) urea, O-methylcarbamatomethyl-methyldimethoxysilane, O-methylcarbamatomethyl-trimethoxysilane, O-ethylcarbamatomethylmethyldiethoxysilane, O-ethylcarbamatomethyltriethoxysilane, 3-methacryloyloxy-propyltrimethoxysilane, methacryloyloxymethyl-trimethoxysilane, methacryloyloxymethylmethyldimethoxysilane, methacryloyloxymethyltriethoxysilane, methacryloyloxymethyl-methyldiethoxysilane, 3-acryloyloxypropyltrimethoxysilane, acryloyloxymethyltrimethoxysilane, acryloyloxymethyl-methyldimethoxysilanes, acryloyloxymethyltriethoxysilane, and acryloyloxymethylmethyldiethoxysilane, and also their partial hydrolysates.

If the compositions of the invention do include adhesion promoters (F), the amounts are preferably 0.5 to 30 parts by weight, more preferably 1 to 10 parts by weight, based in each case on 100 parts by weight of crosslinkable composition.

In one particularly preferred embodiment of the invention, the coating compositions of the invention comprise not only epoxy silanes, more particularly 3-glycidoxypropyltrimethoxysilane, 3-glycidoxypropylmethyldimethoxysilane, 3-glycidoxypropyltriethoxysilane or 3-glycidoxypropylmethyldiethoxysilane or their partial hydrolysates, but also the compounds (D), described as being preferred, more particularly H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OCH₃)₂CH₃, H₂N(CH₂)₂NH(CH₂)₃—Si(OC₂H₅)₃, H₂N(CH₂)₂NH(CH₂)₃—Si(OC₂H₅)₂CH₃ or their partial hydrolysates, in the amounts indicated as being preferred in each case.

Especially preferred is an embodiment of the invention in which the coating compositions of the invention comprise not only epoxy silanes, more particularly 3-glycidoxypropyl-trimethoxysilane, 3-glycidoxypropylmethyldimethoxysilane, 3-glycidoxypropyltriethoxysilane or 3-glycidoxypropylmethyldiethoxysilane or their partial hydrolysates, but also the compounds (D) described as being preferred and possessing a dialkoxysilyl group, more particularly H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₂CH₃, H₂N(CH₂)₂NH(CH₂)₃—Si(OC₂H₅)₂CH₃ or their partial hydrolysates, in the amounts indicated as being preferred in each case.

The water scavengers (G) optionally employed in the coating compositions of the invention may be any desired water scavengers useful for systems which cure by silane condensation.

Examples of water scavengers (G) are silanes such as vinyltrimethoxysilane, vinyltriethoxysilane, vinylmethyl-dimethoxysilane, tetraethoxysilane, O-methylcarbamatomethyl-methyldimethoxysilane, O-methylcarbamatomethyl-trimethoxysilane, O-ethylcarbamatomethylmethyldiethoxysilane, O-ethylcarbamatomethyltriethoxysilane, and/or their partial condensates, and also orthoesters, such as 1,1,1-tri-methoxyethane, 1,1,1-triethoxyethane, trimethoxymethane, and triethoxymethane, with vinyltrimethoxysilane being preferred.

If the coating compositions of the invention do include water scavengers (G), the amounts are preferably 0.5 to 30 parts by weight, more preferably 1 to 10 parts by weight, based in each case on 100 parts by weight of crosslinkable composition. The coating compositions of the invention preferably do comprise water scavengers (G).

The additives (H) optionally employed in the compositions of the invention may be any desired additives typical of silane-crosslinking systems.

The additives (H) optionally employed in accordance with the invention are compounds which are different from the components stated so far, and are preferably antioxidants, UV stabilizers such as HALS compounds, for example, fungicides, biocides or in-can preservatives, commercial defoamers and/or deaerating agents, e.g., SILFOAM® SC 120, 124 or 155 from Wacker Chemie AG, Munich, Germany, or else products from BYK (Wesel, Germany), commercial wetting agents, e.g., from BYK (Wesel, Germany), and pigments.

If the coatings of the invention do include additives (H), the amounts are preferably 0.01 to 30 parts by weight, more preferably 0.1 to 10 parts by weight, based in each case on 100 parts by weight of constituent (A). The coating compositions of the invention preferably do comprise additives (H).

The adjuvants (I) optionally employed in accordance with the invention are preferably tetraalkoxysilanes, e.g., tetraethoxysilane, and/or their partial condensates, plasticizers, reactive diluents, flame retardants, and organic solvents.

Examples of plasticizers (I) are phthalic esters, for example dioctyl phthalate, diisooctyl phthalate, and diundecyl phthalate; perhydrogenated phthalic esters, for example diisononyl 1,2-cyclohexanedicarboxylate and dioctyl 1,2-cyclohexanedicarboxylate; adipic esters such as dioctyl adipate; benzoic esters; glycol esters; esters of saturated alkanediols such as 2,2,4-trimethyl-1,3-pentanediol monoisobutyrates and 2,2,4-trimethyl-1,3-pentanediol diisobutyrates; phosphoric esters; sulfonic esters; polyesters; polyethers, as for example polyethylene glycols and polypropylene glycols preferably having molar masses of 1000 to 10,000 g/mol; polystyrenes; polybutadienes; polyisobutylenes; paraffinic hydrocarbons, and high molecular mass branched hydrocarbons.

The coating compositions of the invention preferably contain no plasticizers (I).

Preferred reactive diluents (I) are compounds which contain alkyl chains having 6 to 40 carbon atoms and possess a group which is reactive toward the compounds (A). Examples are isooctyltrimethoxysilane, isooctyltriethoxysilane, n-octyl-trimethoxysilane, n-octyltriethoxysilane, decyltrimethoxysilane, decyltriethoxysilane, dodecyltrimethoxysilane, dodecyltriethoxysilane, tetradecyltrimethoxysilane, tetradecyltriethoxysilane, hexadecyltrimethoxysilane or hexadecyltriethoxysilane.

As flame retardants (I) it is possible to use all typical flame retardants, especially halogenated compounds and derivatives, more particularly (partial) esters of phosphoric acid that are different from component (E).

Examples of organic solvents (I) are the compounds already stated above as solvents (BL), preferably alcohols, more particularly ethanol.

In one preferred embodiment the coating compositions of the invention contain 0.1 to 30, more preferably 0.5 to 10, parts by weight of solvent, preferably alcohol, more preferably ethanol, based in each case on 100 parts by weight of component (A).

In another preferred embodiment the coating compositions of the invention are solvent-free.

If the coating compositions of the invention do include one or more components (I), the amounts in each case are preferably 0.1 to 200 parts by weight, more preferably 1 to 100 parts by weight, and most preferably 2 to 70 parts by weight, based in each case on 100 parts by weight of component (A).

The coating compositions of the invention are preferably compositions comprising

(A) 100 parts by weight of compounds of the formula (I),

(B) 60 to 1000 parts by weight of silicone resins comprising units of the formula (II),

(C) 75 to 2000 parts by weight of filler (C), with component

(C) consisting at least to an extent of 5 wt % of particles having a particle size of 10 μm to 1 cm,

(D) 0.1 to 40 parts by weight of component (D),

optionally

(E) catalysts,

optionally

(F) adhesion promoters,

optionally

(G) water scavengers,

optionally

(H) additives, and

optionally

(I) adjuvants.

The coating compositions of the invention are more preferably compositions comprising

(A) 100 parts by weight of compounds of the formula (I),

(B) 100 to 500 parts by weight of silicone resins consisting of units of the formula (II),

(C) 200 to 1000 parts by weight of filler (C), with component (C) consisting at least to an extent of 5 wt % of particles having a particle size of 10 μm to 1 cm,

(D) 0.5 to 15 parts by weight of component (D),

optionally

(E) catalysts,

optionally

(F) adhesion promoters,

optionally

(G) water scavengers,

optionally

(H) additives, and

optionally

(I) adjuvants.

The coating compositions of the invention preferably contain no constituents other than components (A) to (I).

The components used inventively may each be one kind of such a component or else a mixture of at least two kinds of any such component.

The coating compositions of the invention may be either self-leveling or trowelable. Self-leveling compositions are achievable by using relatively large proportions of components (A) and (B), amounting in total preferably to at least 24 wt %, based on the overall formulation, and by using sufficiently finely divided fillers. They are applied preferably by pouring out with optional subsequent smoothing, or by rolling or spraying.

Trowelable coatings, on the other hand, contain smaller proportions of components (A) and (B), preferably amounting in total to less than 24 wt %, based on the overall formulation, and contain more coarsely particulate fillers. They are applied preferably by troweling, knife coating or rolling.

The coating compositions of the invention can be produced by any desired and conventional manner, such as, for instance, by methods and mixing techniques of the kind customary in the production of moisture-curing compositions. The sequence in which the various constituents are mixed with one another may be varied arbitrarily.

A further subject of the present invention is a method for producing the composition of the invention by mixing the individual components in any desired order.

This mixing may take place at room temperature under the pressure of the surrounding atmosphere, in other words at about 900 to 1100 hPa. If desired, however, this mixing may also take place at higher temperatures, such as at temperatures in the range from 30 to 130° C. It is possible, moreover, to carry out mixing occasionally or continuously under reduced pressure, such as at 30 to 500 hPa absolute pressure, for example, in order to remove volatile compounds and/or air.

The method of the invention may be carried out continuously or discontinuously.

The coating compositions of the invention are preferably one-component compositions which are storable in the absence of water and which can be crosslinked at room temperature on ingress of water. The coating compositions of the invention, alternatively, may be part of two-component crosslinking systems, in which case OH-containing compounds, such as water, are added in a second component.

The usual water content of the air is sufficient to crosslink the coating compositions of the invention. Crosslinking of the coating compositions of the invention is preferably accomplished at room temperature. It may, if desired, also be carried out at temperatures higher or lower than room temperature, as for example at −5° to 15° C. or at 30° to 80° C., and/or by means of water concentrations which exceed the normal water content of the air.

Preferably the crosslinking is conducted at a pressure of 100 to 1100 hPa, more particularly under the pressure of the surrounding atmosphere, in other words at about 900 to 1100 hPa.

A further subject of the invention are shaped articles produced by crosslinking the compositions of the invention. The shaped articles of the invention are preferably coatings.

A further subject of the invention is a method for producing coatings wherein the coating composition of the invention is applied to at least one substrate and subsequently caused to crosslink.

The substrate preferably comprises mineral materials, more preferably concrete surfaces or screed surfaces, more particularly concrete floors or screed floors.

The coatings of the invention are preferably floor coatings. More preferably they are floor coatings which are applied to a substrate consisting of concrete or screed.

In the method of the invention, application may take place by any desired techniques known to date, such as pouring, troweling, and brushing, for example.

The coating compositions of the invention in this case may be applied directly to the substrate, e.g., concrete, screed or cast asphalt. The substrate is preferably cleaned before the coating composition of the invention is applied; such cleaning ought in particular to remove loose parts, growth of lichens, algae or plants, grease, paraffin, release agents, and other contaminants. Pores, cavities or gravel pockets should preferably be filled in before the coating is applied. If the coating is applied directly to concrete, it is often advantageous for the age of the concrete to be at least 4 weeks. Fundamentally it is the case that effective adhesion is advantaged if the surface has a certain roughness and key.

Particularly in order to improve adhesion to wet concrete, however, it may also be of advantage for a primer to be applied beforehand. Suitable primers are, in particular, formulations which comprise silicone resins such as the abovementioned compounds (B), and alkoxysilanes such as the abovementioned reactive diluents (I), adhesion promoters (F), or the above-described nitrogen-containing organosilicon compound (D), more preferably alkylsilanes, such as isooctyl- and n-octyl-trialkoxysilanes or hexadecyltrialkoxysilanes, and also aminosilanes, such as H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OCH₃)₂CH₃, H₂N(CH₂)₂NH(CH₂)₃—Si(OC₂H₅)₃, H₂N(CH₂)₂NH(CH₂)₃—Si(OC₂H₅)₂CH₃, and also their partial hydrolysates in each case.

These primers may comprise the aforementioned compounds in undiluted form or in the form of a solution or emulsion.

The coating compositions of the invention possess, after curing, a high tensile adhesive strength on dry and wet concrete, screed, and cast asphalt, preferably amounting to at least 1.5 N/mm², and also good chemical resistance. The tensile adhesive strength is determined according to DIN EN 13813, by using a tensile testing machine to slowly and uniformly pull up a die (so-called test die), adhered to the coating of the test specimen in question, pulling being carried out perpendicularly to the substrate surface and continuing until tearing takes place (fracture), all under defined conditions (measurement area, temperature, pulling speed, etc.).

The coating compositions of the invention are preferably applied in layer thicknesses of at least 300 μm, more preferably of at least 600 μm.

The coating compositions of the invention have the advantage that they are easy to produce.

The crosslinkable coating compositions of the invention have the advantage that they are notable for very high storage stability and a high crosslinking rate.

The crosslinkable coating compositions of the invention have the advantage, moreover, that they are easy to work.

In the examples described below, all viscosity figures are based on a temperature of 23° C. Unless otherwise indicated, the examples below are carried out at a pressure of the surrounding atmosphere, i.e., approximately at 1000 hPa, and at room temperature, i.e., at approximately 23° C., or at a temperature which comes about when the reactants are combined at room temperature without additional heating or cooling, and also at a relative humidity of about 50%. Furthermore, all figures for parts and percentages, unless otherwise specified, are given by weight.

### EXAMPLES

The examples below used the following substances:

GENIOSIL® STP-E10: Silane-terminated polypropylene glycol having an average molar mass (Mₙ) of 12,000 g/mol and end groups of formula —O—C(═O)—NH—CH₂—SiCH₃(OCH₃)₂ (available commercially from Wacker Chemie AG, Munich (DE));

GENIOSIL® STP-E15: Silane-terminated polypropylene glycol having an average molar mass (Mₙ) of 12,000 g/mol and end groups of formula —O—C(═O)—NH—(CH₂)₃—Si(OCH₃)₃ (available commercially from Wacker Chemie AG, Munich (DE));

GENIOSIL® LX 368: Solvent-free, liquid phenylsilicone resin composed of phenyl-functional T units (60-65 wt %), methyl-functional T units (18-22 wt %), and dimethyl-functional D units 2-4 wt %), having a methoxy group content of 12-16 wt % and an average molar mass of 800-1300 g/mol (available commercially from Wacker Chemie AG, Munich (DE));

GENIOSIL® LX 678: Solvent-free, liquid phenylsilicone resin which is composed exclusively of phenyl-functional T units and has a methoxy group content of 10-30 wt % and an average molar mass of 1000-2000 g/mol (available commercially from Wacker Chemie AG, Munich (DE));

GENIOSIL® GF 9: N-(2-Aminoethyl)-3-aminopropyl-trimethoxysilane (available commercially from Wacker Chemie AG, Munich (DE));

GENIOSIL® GF 80: 3-Glycidoxypropyl-trimethoxysilane (available commercially from Wacker Chemie AG, Munich (DE));

GENIOSIL® GF 95: N-(2-Aminoethyl)-3-aminopropyl-methyldimethoxysilane (available commercially from Wacker Chemie AG, Munich (DE));

GENIOSIL® GF 96: 3-Aminopropyl-trimethoxysilane (available commercially from Wacker Chemie AG, Munich (DE));

GENIOSIL® XL 926: N-Cyclohexylaminomethyl-triethoxysilane (available commercially from Wacker Chemie AG, Munich (DE));

SILFOAM® SC 124 deaerating agent: Anhydrous, low-viscosity, liquid defoamer compound based on polydimethylsiloxane, having a dynamic viscosity of less than 4000 mPas (Brookfield Spindle 2; 2.5 rpm; at 25° C.);

HDTMS: Hexadecyltrimethoxysilane;

EFA Fuller HP: Binder consisting essentially of SiO₂ and Al₂O₃, with a particle fraction >10 μm of 64 wt %, particle fraction >20 μm of 47 wt %, a particle fraction >30 μm of 37 wt %, a particle fraction >40 μm of 31 wt %, and a bulk density of 1.20 g/cm² (available commercially from Baumineral, Herten (DE));

Silica sand F36: Silica sand with a grading of 0.09 to 0.355 mm, an average particle size of 0.16 mm, a particle fraction >90 μm of >99 wt %, a bulk density of 1.4 g/cm³, and a theoretical specific surface area of 144 cm²/g (available commercially from Quarzwerke GmbH, Frechen (DE));

Silica sand HR 81T: Silica sand with a grading of 0.063 to 0.71 mm, an average particle size of 0.13 mm, a particle fraction >63 μm of >99 wt %, a bulk density of 1.32 g/cm³ (fire-dried), and a theoretical specific surface area of 175 cm²/g (available commercially from Quarzwerke Österreich GmbH, Melk (AT));

Ground quartz W8 (1-100 μm): Finely ground quartz having a grading of 0.001-0.16 mm, an average particle size of 0.026 mm, a particle fraction >10 μm of 76 wt %, a particle fraction >20 μm of 59 wt %, a particle fraction >30 μm of 44 wt %, a particle fraction >40 μm of 40 wt %, and a bulk density of 0.9 g/cm³ (available commercially from EUROQUARZ GmbH, Dorsten (DE));

Silica sand BCS 413: Silica sand with a grading of 0.063 to 0.355 mm, an average particle size of 0.13 mm, a particle fraction >63 μm of >99 wt %, a bulk density of 1.32 g/cm³ (fire-dried), and a theoretical specific surface area of 175 cm²/g (available commercially from Quarzwerke Österreich GmbH, Melk (AT));

Talc N (1-100 μm): Pulverized magnesium silicate hydrate having a particle size of less than 0.063 mm (max. residue 3.5% on sieving), a bulk density of about 0.6 g/cm³, and a specific surface area of at least 9500 cm²/g.

### Examples 1 to 5: Production of Trowelable 1-Component Coating Compositions

All compounds are used in accordance with the weight proportions specified in table 1.

The dry fillers are premixed dry by simple stirring together with a laboratory spatula. Then the silicone resin and the silane-terminated polyether are mixed separately with a Speedmixer™ DAC 150.1 FVZ for 1 minute at 2500 rpm. Next the further liquid components specified in table 1 are added and mixing takes place again in the Speedmixer™ DAC 150.1 FVZ for 15 seconds at 2500 rpm. The dry filler mixture is added to this mixture, and mixed in by means of a further stirring procedure in the Speedmixer™ DAC 150.1 FVZ for 1 minute at 2500 rpm.

The ready-to-use mixtures are introduced into containers which can be given an airtight closure. In these containers they can be kept in the absence of atmospheric moisture for at least 6 months. Immediately prior to use, the mixture is reagitated with either a spatula or a manual stirrer, until the mixture is homogeneous again.

TABLE 1

| | Example | | | | |
|---|---|---|---|---|---|
| | 1 | 2 | 3 | 4 | 5 |
| GENIOSIL ® LX 368 | 15.4 | 11.6 | 7.7 | 6.3 | 15.5 |
| GENIOSIL ® STP-E10 | 7.7 | 11.6 | 15.4 | 12.0 | 0.0 |
| GENIOSIL ® STP-E15 | 0.0 | 0.0 | 0.0 | 0.0 | 7.6 |
| GENIOSIL ® GF 9 | 1.0 | 1.0 | 1.0 | 1.0 | 1.2 |
| Ethanol | 3.8 | 3.4 | 3.8 | 3.8 | 0 |
| HDTMS | 0.0 | 0.0 | 0.0 | 0.0 | 2.9 |
| Dioctyltin dilaurate | 0.0 | 0.0 | 0.0 | 0.0 | 0.1 |
| Silica sand BCS 413 | 11.5 | 11.6 | 11.5 | 11.5 | 11.6 |
| Silica sand F36 | 26.9 | 27.1 | 26.9 | 29.8 | 27.2 |
| Silica sand HR 81T | 22.1 | 22.2 | 22.1 | 24.0 | 22.3 |
| Ground quartz W8 | 5.8 | 5.8 | 5.8 | 5.8 | 5.8 |
| Talc N | 5.8 | 5.8 | 5.8 | 5.8 | 5.8 |

The ready-to-use systems are applied by hand, using a trowel, in a layer thickness of about 3 mm to concrete paving slabs having a thickness of about 3.7 cm. The slabs are then stored under standard conditions (23° C./50% humidity) for 28 days.

In a further experiment, the concrete slabs are stored in water for 7 days immediately prior to their coating, and are left to drip dry for 60 minutes. These slabs as well, after having been coated, are stored under standard conditions (23° C./50% humidity) for 28 days.

Tensile adhesion testing takes place in accordance with DIN EN 1348. For this purpose, the surface of the coating is abraded with sand paper. Steel dies having a square base area with an edge length of 5 cm and a thickness of 1 cm are then adhered using a rapid adhesive (from Delo; Automix AD895; 2-component epoxy resin adhesive). Following curing of the adhesive, after 24 hours, the coating is incised down to the underlying concrete at the die edges. Thereafter the dies are pulled up using a tensile adhesion tester of type HP 850 from Herion, the tensile force beginning at 0 N and increasing at a constant rate of 100 N/s until tearing takes place. Each tensile adhesion measurement is carried out four times, and the results are averaged. These average values, including standard deviation, are found in table 2.

TABLE 2

| | Example | | | | |
|---|---|---|---|---|---|
| | 1 | 2 | 3 | 4 | 5 |
| Application | 5.4 ± 0.6 | 5.7 ± 0.4 | 4.3 ± 0.5 | 4.4 ± 0.3 | 6.1 ± 0.5 |
| to dry | | | | | |
| concrete | | | | | |
| [N/mm²] | | | | | |
| Application | 1.8 ± 0.3 | 2.9 ± 0.3 | 1.9 ± 0.3 | 2.3 ± 0.4 | 2.1 ± 0.3 |
| to wet | | | | | |
| concrete | | | | | |
| [N/mm²] | | | | | |

### Examples 6 to 9: Production of Trowelable 1-Component Floor Coating Compositions

All compounds are used in the weight proportions reported in table 3. The compositions are produced in the same way as for examples 1 to 5.

The purpose of these examples is to illustrate the influence exerted by the various crosslinkers on the adhesion properties of the coatings of the invention.

TABLE 3

| | Example | | | | |
|---|---|---|---|---|---|
| | 1 | 6 | 7 | 8 | 9 |
| GENIOSIL ® LX 368 | 15.4 | 15.4 | 15.4 | 15.4 | 15.4 |
| GENIOSIL ® STP-E10 | 7.7 | 7.7 | 7.7 | 7.7 | 7.7 |
| GENIOSIL ® GF 9 | 1.0 | 0.0 | 0.0 | 0.0 | 0.0 |
| GENIOSIL ® GF 80 | 0.0 | 0.0 | 0.5 | 0.0 | 0.0 |
| GENIOSIL ® GF 95 | 0.0 | 1.0 | 0.5 | 0.5 | 0.0 |
| GENIOSIL ® GF 96 | 0.0 | 0.0 | 0.0 | 0.0 | 1.0 |
| GENIOSIL ® XL 926 | 0.0 | 0.0 | 0.0 | 0.5 | 0.0 |
| Ethanol | 3.8 | 3.8 | 3.8 | 3.8 | 3.8 |
| Silica sand BCS 413 | 11.5 | 11.5 | 11.5 | 11.5 | 11.5 |
| Silica sand F36 | 26.9 | 26.9 | 26.9 | 26.9 | 26.9 |
| Silica sand HR 81T | 22.1 | 22.1 | 22.1 | 22.1 | 22.1 |
| Ground quartz W8 | 5.8 | 5.8 | 5.8 | 5.8 | 5.8 |
| Talc N | 5.8 | 5.8 | 5.8 | 5.8 | 5.8 |

Application of the coatings and adhesion testing measurements takes place likewise as described for examples 1 to 5.

In this case the coatings are always applied to dry concrete slabs. After that, however, the coated concrete slabs are stored differently. In a first series of experiments, the slabs, just as in examples 1-5, are stored under standard conditions (23° C./50% humidity) for 28 days. In a second series of experiments, the slabs are stored under standard conditions for 7 days and directly thereafter for 21 days under water, standing on their edge. In a third series of experiments, the slabs are stored under standard conditions for 7 days and immediately thereafter for 21 days under water, standing on their edge, whereupon 15 freeze-thaw cycles are carried out, as described in section 8.5 of DIN EN 1348. Immediately after the respective storage procedure, the adhesion test measurements are carried out as described in the case of examples 1 to 5. The results are found in table 4.

TABLE 4

| Storage | Example 1 | Example 6 | Example 7 | Example 8 | Example 9 |
|---|---|---|---|---|---|
| 28 d under | 5.4 ± 0.6 | 5.9 ± 0.3 | 6.8 ± 0.6 | 6.8 ± 0.7 | 6.7 ± 0.6 |
| standard | | | | | |
| conditions | | | | | |
| [N/mm²] | | | | | |
| 7 days | 0.8 ± 0.1 | 1.3 ± 0.6 | 2.1 ± 0.6 | 1.1 ± 0.4 | 0.6 ± 0.1 |
| standard | | | | | |
| conditions, | | | | | |
| 21 days | | | | | |
| under | | | | | |
| water | | | | | |
| [N/mm²] | | | | | |
| Freeze-thaw | 0.3 ± 0.1 | 1.2 ± 0.2 | 1.6 ± 0.3 | 1.0 ± 0.1 | 0.1 ± 0.0 |
| storage | | | | | |
| [N/mm²] | | | | | |

It emerges that in particular through the use of GENIOSIL® GF95, which is an amino-functional silane having a dialkoxysilyl group, particularly good adhesion values can be achieved. A further improvement can be achieved through combination with the epoxy-functional GENIOSIL® GF80.

### Example 10: Production of Trowelable 1-Component Floor Coating Compositions

All compounds are used in the weight proportions reported in table 5. The compositions are produced in the same way as for examples 1 to 5.

The purpose of these examples is to illustrate the influence exerted by different primers on the adhesion properties of the coatings of the invention.

TABLE 5

| | Example 10 |
|---|---|
| GENIOSIL ® LX 368 | 15.8 |
| GENIOSIL ® STP-E10 | 4.0 |
| GENIOSIL ® GF 9 | 1.0 |
| Ethanol | 1.0 |
| HDTMS | 4.0 |
| Silica sand BCS 413 | 11.9 |
| Silica sand F36 | 27.7 |
| Silica sand HR 81T | 22.8 |
| Ground quartz W8 | 5.9 |
| Talc N | 5.9 |

The ready-to-use composition is applied by hand, using a trowel, in a layer thickness of about 3 mm to concrete paving slabs having a thickness of about 3.7 cm, to which beforehand a primer has been applied by brush, the amount of primer applied being about 100 g per m². Application of the coating then takes place wet-on-wet directly after the application of the respective primer.

### Primer 1 (P1):

Liquid silicone resin having the average composition (MeSiO_{3/2})_{0.19}(i-OctSiO_{3/2})_{0.05}(MeSi(OMe)O_{2/2})_{0.30}(i-OctSi(OMe)O_{2/2})_{0.08}(MeSi(OMe)₂O_{1/2})_{0.16} (i-OctSi(OMe)₂O_{1/2})_{0.07}(Me₂SiO_{2/2})_{0.15} and an average molecular weight Mn of 550 g/mol and a polydispersity of 2.8;

### Primer 2 (P2):

Hexadecyltrimethoxysilane.

The storage conditions of the inventively coated concrete slabs and also the adhesion test measurements take place just as described in examples 6 to 9. The results are found in table 6.

TABLE 6

| | Example | | | | | |
|---|---|---|---|---|---|---|
| | 1 | 10 | 1 | 10 | 1 | 10 |
| Storage | unprimed | unprimed | P1 | P1 | P2 | P2 |
| 28 d under | 5.4 ± 0.6 | 3.8 ± 0.4 | 5.3 ± 0.5 | 4.1 ± 0.2 | 5.3 ± 0. 6 | 3.6 ± 0.4 |
| standard | | | | | | |
| conditions | | | | | | |
| [N/mm²] | | | | | | |
| 7 days | 0.8 ± 0.1 | 1.3 ± 0.1 | 2.9 ± 0.2 | 2.7 ± 0.3 | 3.9 ± 0.1 | 3.5 ± 0.2 |
| standard | | | | | | |
| conditions, | | | | | | |
| 21 days | | | | | | |
| under water | | | | | | |
| [N/mm²] | | | | | | |
| Freeze-thaw | 0.3 ± 0.1 | 1.0 ± 0.3 | 1.3 ± 0.3 | 2.2 ± 0.2 | 2.9 ± 0.3 | 2.5 ± 0.3 |
| storage | | | | | | |
| [N/mm²] | | | | | | |

### Examples 11 to 14: Production of Self-Leveling 1-Component Floor Coating Compositions

All compounds are used in accordance with the weight proportions reported in table 7. The compositions are produced in analogy to examples 1 to 5.

TABLE 7

Example

| | 11 | 12 | 13 | 14 |
|---|---|---|---|---|
| GENIOSIL ® LX 678 | 19.9 | 16.8 | 12.2 | 9.7 |
| GENIOSIL ® STP-E10 | 5.0 | 7.9 | 12.2 | 14.5 |
| GENIOSIL ® GF 80 | 0.8 | 0.8 | 0.8 | 0.8 |
| GENIOSIL ® GF 95 | 0.8 | 0.8 | 0.8 | 0.8 |
| SILFOAM ® SC 124 | 0.8 | 0.7 | 0.7 | 0.7 |
| Ethanol | 0.0 | 1.0 | 2.0 | 2.9 |
| Silica sand F36 | 24.9 | 24.7 | 24.4 | 24.2 |
| Silica sand BCS 413 | 24.9 | 24.7 | 24.4 | 24.2 |
| EFA Fuller HP | 22.9 | 22.6 | 22.5 | 22.2 |

All compositions described in examples 11 to 14 are self-leveling, meaning that they form a smooth surface following application to a horizontal substrate. Application in this case takes place by simple pouring.

1.-10. (canceled)

11. A crosslinkable coating composition, comprising:
(A) 100 parts by weight of one or more compounds (A) of the formula
Y—[(CR¹₂)_{b}—SiRₐ(OR²)₃₋ₐ]ₓ (I),
where
Y is an x-valent polymer radical bonded via nitrogen, oxygen, sulfur or carbon,
R are identical or different and are monovalent, optionally substituted, SiC-bonded hydrocarbyl radicals,
R¹ are identical or different and are hydrogen or monovalent, optionally substituted hydrocarbyl radicals, which may be attached via nitrogen, phosphorus, oxygen, sulfur or carbonyl group to the carbon atom,
R² are identical or different and are hydrogen or monovalent, optionally substituted hydrocarbyl radicals,
x is an integer from 1 to 10,
a each individually is 0, 1 or 2, and
b each individually is an integer from 1 to 10,
(B) more than 10 parts by weight of one or more silicone resins comprising units of the formula
R³_{c}(R⁴O)_{d}R⁵ₑSiO_{(4-c-d-e)/2} (II),
where
R3 are identical or different and are hydrogen or monovalent, SiC-bonded, optionally substituted aliphatic hydrocarbyl radicals, or a divalent, optionally substituted, aliphatic hydrocarbyl radical which bridges two units of the formula (II),
R4 are identical or different and are hydrogen or monovalent, optionally substituted hydrocarbyl radicals,
R5 are identical or different and are monovalent, SiC-bonded, optionally substituted aromatic hydrocarbyl radicals,
c is 0, 1, 2 or 3,
d is 0, 1, 2 or 3, and
e is 0, 1 or 2,
with the proviso that the sum of c+d+e is less than or equal to 3 and in at least 40% of the units of the formula (II) the sum c+e is 0 or 1,
and
(C) more than 50 parts by weight of inorganic fillers, where component (C) contains at least to an extent of 5 wt. %, of particles having a particle size of 10 μm to 1 cm.

12. The crosslinkable composition of claim 11, wherein radical Y in formula (I) comprises polyurethane radicals or polyoxyalkylene radicals.

13. The crosslinkable composition of claim 11, comprising compounds (A) in a concentration of at most 40 wt. % and at least 3 wt. %. Based on the total weight of the composition.

14. The crosslinkable composition of claim 12, comprising compounds (A) in a concentration of at most 40 wt. % and at least 3 wt. %. Based on the total weight of the composition.

15. The crosslinkable composition of claim 11, comprising at least 60 parts by weight of component (B), based on 100 parts by weight of component (A).

16. The crosslinkable composition of claim 12, comprising at least 60 parts by weight of component (B), based on 100 parts by weight of component (A).

17. The crosslinkable composition of claim 13, comprising at least 60 parts by weight of component (B), based on 100 parts by weight of component (A).

18. The crosslinkable composition of claim 11, wherein the fillers are aluminum oxide-containing and/or silicon oxide-containing fillers.

19. The crosslinkable composition of claim 11, wherein component (C) contains to an extent of at least 10 wt. %, of particles having a particle size of 20 μm to 2000 μm.

20. The crosslinkable compositions of claim 11, comprising 75 to 1000 parts by weight of fillers (C), based on 100 parts by weight of constituent (A).

21. A method for producing a crosslinkable composition of claim 11, comprising mixing the individual components in any desired order.

22. A shaped article produced by crosslinking a composition of claim 11.

23. A shaped article produced by crosslinking a composition prepared by the method of claim 21.

24. A method for producing coatings, comprising applying a coating composition of claim 11, to at least one substrate and subsequently crosslinking the composition.
